(19) United States
(12) Patent Application Publication
(10) Pub. No.: US 2010/0011093 A1
(43) Pub. Date: Jan. 14, 2010

(54) MULTIPLE IDENTITY DOWNLOAD MANAGER

(75) Inventor: Michael M. Gordon, Paradise Valley, AZ (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Limelight Networks, Inc., Tempe, AZ (US)

(21) Appl. No.: 12/502,864

(22) Filed: Jul. 14, 2009

Related U.S. Application Data
(60) Provisional application No. 61/080,608, filed on Jul. 14, 2008.

(51) Int. Cl. G06F 15/16

(52) U.S. Cl. 709/219

(57) ABSTRACT

A method and apparatus for downloading files from a plurality of content sources is disclosed. The downloading is performed with a download manager that has a number of instances each customized with a personality to respectively implement a use case. The personality can specify bandwidth requirements, QoS factors, reporting locations, authentication requirements, player or application to use with the content, how the graphical user interface is customized, information to track, location for downloads, security and privacy settings, and/or how customizations is inherited. The personality may also specify the protocols and/or encryption used for the download.

This application claims the benefit of and is a non-provisional of co-pending U.S. Provisional Application Ser. No. 61/080,608 filed on Jul. 14, 2008, which is hereby expressly incorporated by reference in its entirety for all purposes.

### BACKGROUND

This disclosure relates in general to content downloading and, but not by way of limitation, to Internet download of remote content files.

Browsers and operating systems have the ability to manage the download of files. Operations such as regulating the download, pausing download and resuming download are operations common to these download managers. When a download is canceled, it is restarted from the beginning. Bandwidth management can also be provided where the Internet connection or computer processor is not overwhelmed in performing the download. Some download managers can specify an immediate download or a download to be performed at a later time. The download manager can hold a history of past downloads.

There are many different download managers used on a typical computing device. For example, there are separate download managers for video playback, music streaming or download, software download, software upgrades, etc. Each different download manager requires a different download of a different application. Often, a pop-up window will confirm the user's intention to receive and execute the download manager where the user can indicate to accept the software or not. The download manager could be a plug-in or an installed application. Even where two download managers may have a similar code base, customizations that define how the software behaves are compiled into each download manager.

### SUMMARY

In one embodiment, the present disclosure provides methods and apparatuses for downloading files from a number of content sources. The downloading is performed with a download manager that has a number of instances each customized with a personality to respectively implement a use case. The personality can specify bandwidth requirements, QoS factors, reporting locations, authentication requirements, player or application to use with the content, how the graphical user interface is customized, information to track, location for downloads, security and privacy settings, and/or how customizations is inherited. The personality may also specify the protocols and/or encryption used for the download.

In another embodiment, a method for customizing a download manager on a user computer according to a number of content sources is disclosed. The download manager is downloaded onto a computing device. A first personality corresponding to a first content source that is part of the number of content sources is downloaded. The first personality is loaded to customize the download manager. First content from the first content source is downloaded. A second personality corresponding to a second content source that is part of the number of content sources is downloaded. The second personality is loaded to customize the download manager. Second content from the second content source is downloaded.

In another embodiment, a file download system for electronically transmitting content files from a number of content sources to a user computing device using the Internet is disclosed. A download manager is used by the user computing device. The download manager comprises: a personality database comprising a number of personalities for the number of content sources, where the number of personalities can be invoked independently when encountering a corresponding one of the number of content sources to customize a particular download manager; and a reporting function that reports to different locations as defined by the number of personalities.

In another embodiment, a file download manager for electronically transmitting content files from a number of content sources to a user computing device over the Internet is disclosed. The file download manager includes a download controller, a personality database and a reporting function. The personality database comprises a number of personalities for the number of content sources. The number of personalities can be invoked independently when encountering a corresponding one of the number of content sources to customize a particular download manager. The reporting function report to different locations as defined by the number of personalities.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIGS. 1A, 1B and 1C each depict a block diagram of an embodiment of a download system;

FIGS. 2A and 2B each illustrate a flowchart of an embodiment of a process for using a download manager; and

FIGS. 3A and 3B each illustrate a flowchart of an embodiment of a process for report grouping.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It being understood that various changes may be made in the function and arrangement of elements without departing from the spirit and scope as set forth in the appended claims.

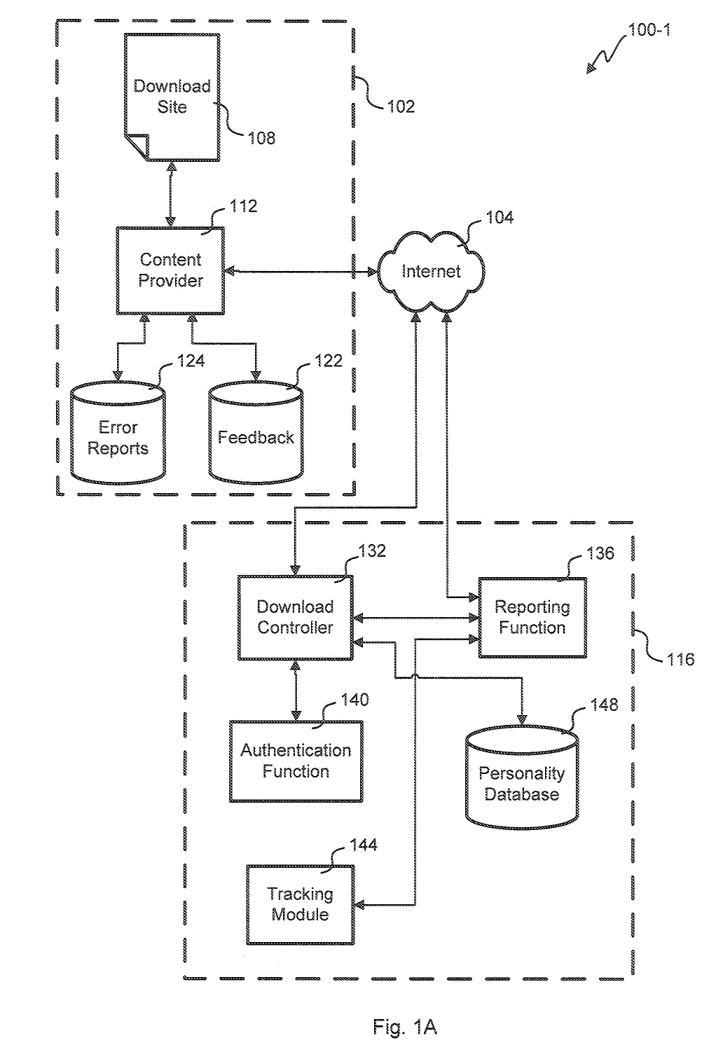

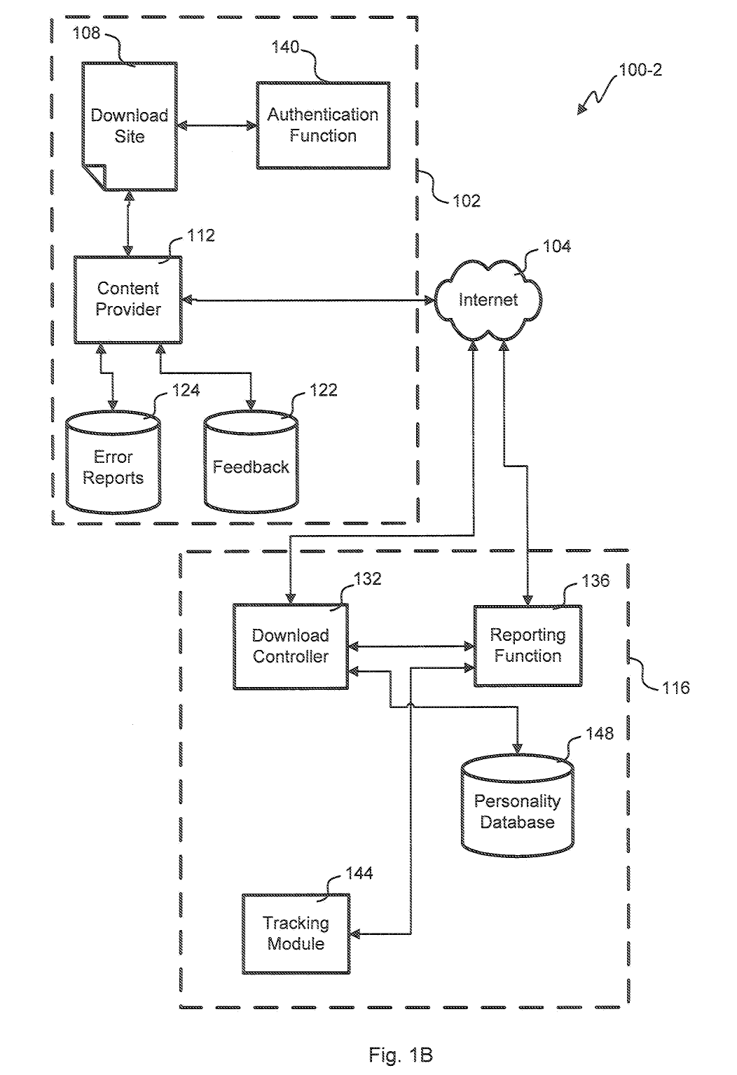

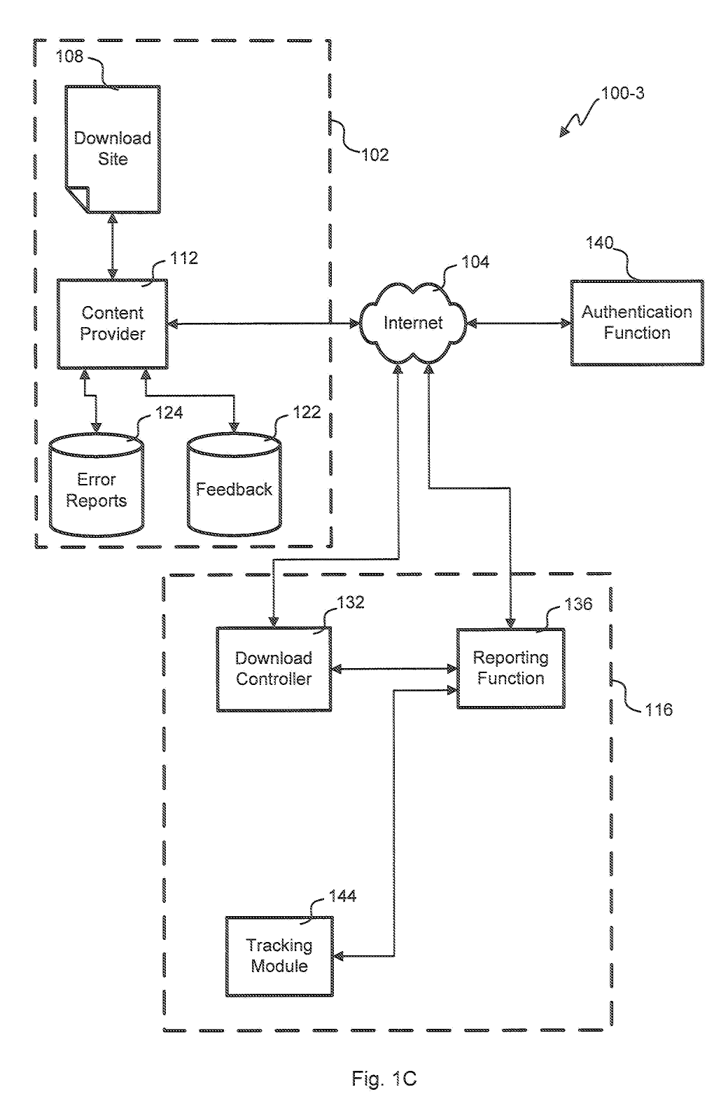

Referring initially to FIG. 1A, an embodiment of a download system 100-1 is shown. Included in the download system 100 are one or more content distributors 102 and one or more download managers 116. The figure only includes a single content distributor 102 and a single download manager 116, but it is to be understood that there are many of each in a typical download system 100. Instances of the download manager 116 are installed on user computers to facilitate download of content from various content providers 112. One instance of the download manager 116 can operate with any number of content providers. The content distributor 102 includes a download site 108, a content provider 112, an error reports database 124, and a feedback database 122.

The download manager 116 is amorphous in that it is customized with various personalities to conform with various content providers 112 and download sites 108, as well as various use cases used or supported by a content provider 112, download site 108, or group of content providers 122 or download sites 108. Various instances of the download manager 116 may be used cross-platform for any number of VoIP phones, personal digital assistants, media playing software or hardware, portable computers, desktop computers, set top boxes, game consoles, personal video recorders, optical disc players, IPTV players, or other content realizing devices. Various platforms would have natively coded download managers 116 as needed by their respective operating systems, but could have common use cases in some instances.

There are many use cases that might be applicable to different situations in which a download manager 116 might be used. Various content providers 112 have different use cases particular to their particular application. Each download site 108 can have a unique use case, for example, that guides development of a personality that is applied to the download manager 116 to suit the use case. For example, use cases are different for streaming live events, streaming pre-recorded content, file download, etc. and can be handled very differently by the download manager 116. Alternatively, a use case could be shared by multiple download sites 108 and content providers 112, for example, where multiple distributors provide the same digital product, or digital products from among the same family of digital products or brand of digital products.

Each instance of the download manager is uniquely identified to the content provider. An instance of the download manager is defined herein as a download manager application customized with a personality, for example, a download manager may have five personalities such that there are potentially five instances that may or may not be active concurrently. After downloading an instance of the download manager, the user enters some type of identifying information for authentication. For example, the user might enter a user name and password. After entry of the identifying information, the content provider can attribute the instance of the download manager to a particular account while uniquely identifying the instance.

The use cases are used to design a personality that can be applied to customize the download manager 116 temporarily for a particular content download. The use case can specify quality of service, where any error reports or feedback should be sent, authentication requirements, how the graphical user interface can be customized, information to track, location for downloads, security and privacy settings, how user customizations is inherited, etc. The use case may also specify the protocols and encryption used for the download, for example, secure sockets layer (SSL) or hyper text transfer protocol (HTTP). Some embodiments allow the download manager 116 to service a number of downloads from a number of different download sites simultaneously. In one example, a user may indicate that a video streaming personality should maintain a particular bandwidth and that override for that personality could be inherited by all video streaming personalities that allow customizations to be inherited.

A personality can be loaded into the personality database 148 at run-time or after the application is running to provide for a particular use case. These personalities are parameterized or soft coded to allow customization of the download manager 116 after the application is compiled. Other embodiments could use a table, configuration file or other mechanism to hold the personalities. In this embodiment, the personality is invoked or keyed off interaction with a particular download site 108 or the digital products that have been received from a particular download site 108. The download site may be represented by one or more IP addresses, one or more Internet domains, or one or more URLs; however, the download manager need not be connected to the download site 108 or the Internet to employ a particular personality. For example, an off-line user could review her download history related to a particular download site 108 or its products, and when she did so, the download manager would utilize the particular personality to control the user interface graphics and the data available to her.

Some embodiments could include one or more content delivery networks (CDN) that are used to deliver the content instead of the content provider. Error reports and feedback could also be gathered by the CDN and provided back to the content publisher. In other embodiments, the CDN could host one or more content publishers in one or more points of presence on the Internet.

A tracking module 144 provides the ability to gather error reports and other feedback. The personality loaded at the time will specify what information to gather or ignore. A reporting function 136 knows where to upload error reports and feedback. The active personality stores the remote location addresses or domains of an error report database 124 and/or a feedback database 122. In this embodiment, only an active personality can gather information and have it reported remotely.

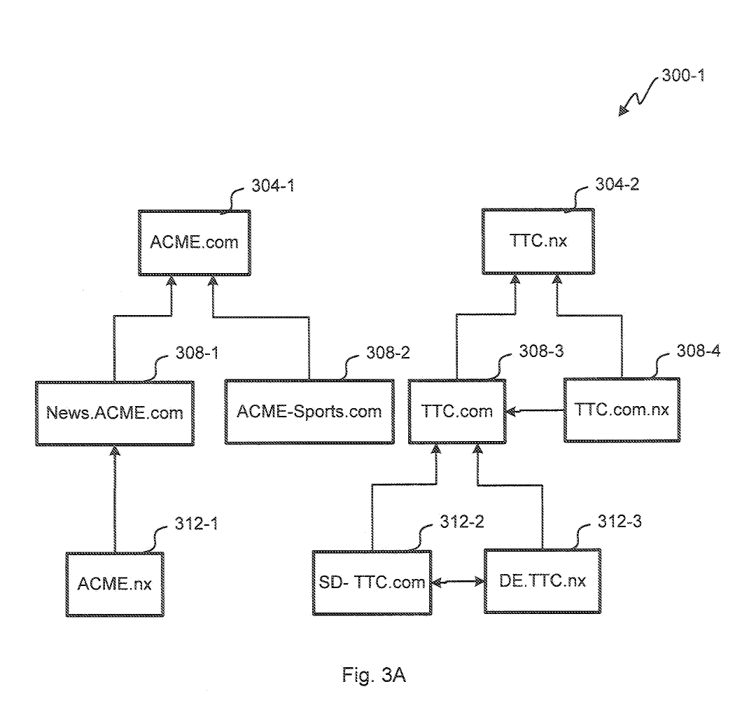

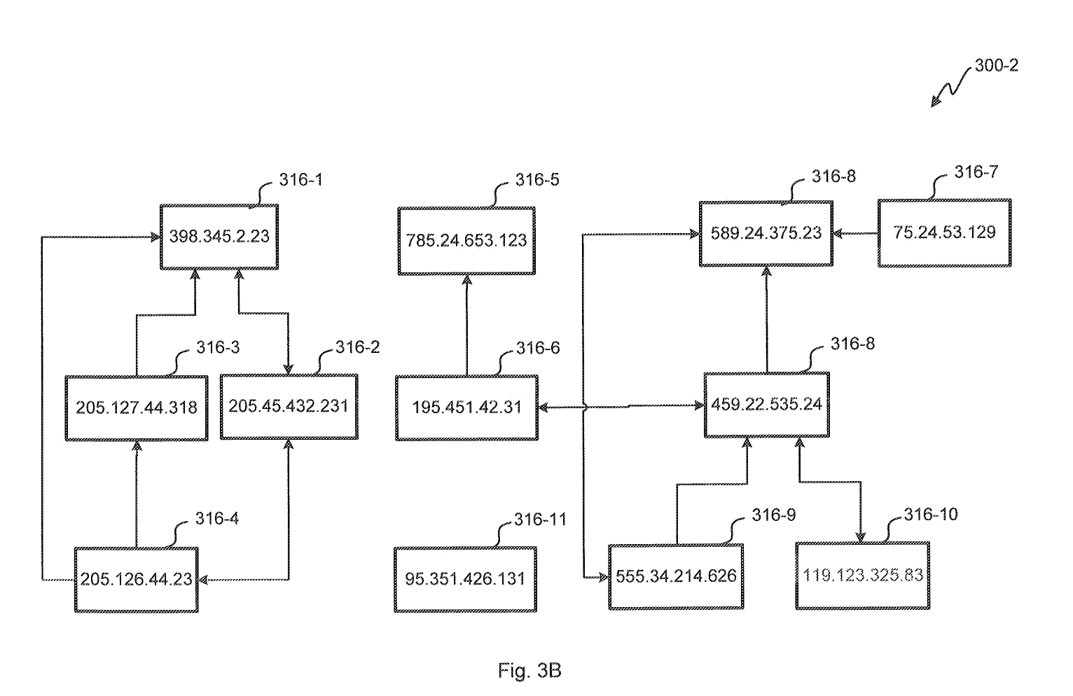

Other personalities cannot get information gathered by any other personality unless there is a grouping of personalities as described below in relation to FIGS. 3A and 3B or unless they are otherwise permitted by that personality to do so. In other words, the personality providing the information can have rules on which other personalities or classes of personalities it will share information with. The rules might specify that some information is to be shared while other information is not shared. For example, the QoS requirements of the download maybe shared, but not demographic information that would identify the person that initiated the download is not shared.

Additionally, the personality is unique to a content publisher 102 in this embodiment. Other embodiments could have a few global personalities that can each be used by a number of instances of the download manager. For example, there could be a video download personality used by a Flash™ video player applet and an IPTV video player. Customizations to the personality would affect all download managers using the personality. Tracking and reporting would be defined by the personality, but could report to different locations or a central location in various embodiments.

A download controller 132 within the download manager 116 manages the download process, reporting, any authentication, loading personalities, etc. The download controller 132 can simultaneously download multiple files while operating under multiple personalities. Each personality is associated with one or more URIs or one or more IP addresses. When a file or stream is requested, the download controller finds the relevant personality; opens a window for that download; invokes any player, application or applet associated with the file or stream; and downloads the file. The personality can provide a skin for the window, custom graphics and content to appear in the window. From the perspective of the user, it appears like each instance of the download manager is a separate application.

A particular content publisher 102 may have more than one personality for a given domain or IP address. Different file and stream types could invoke different personalities. Parameters embedded in the URI could also select a different personality. The name of the file or stream could invoke different personalities. Protocol handshaking or metadata could signal use of a different personality.

For errors, the content provider 112 might have a web service to gather error or bug reports from all the download managers 116 into an error report database 124. If dictated by the use case, errors or bug reports are gathered from all the instances of the download manager 116 according to the personality. The web service for gathering the error reports is located at a particular web address or universal resource locator (URL) that is programmable in the personalities for a particular use case. The error reports can include download failures or stoppages, memory stacks, digital rights management (DRM) tampering, download status, bandwidth profiles, processor loading, operating system errors, application errors, QoS compliance, etc.

Some embodiments of the download manger also provide a mechanism to provide feedback or data to web service located at a programmable web address or URL. In this way, the download manager 116 can also upload information to the content provider 112. The contents of the feedback is customizable by the particular use case. Examples of feedback that could be chosen in the personality include download history, download queue, download time, bandwidth of downloads, micro credits consumed, cost of content, etc.

The download manager 116 also includes an authentication function 140 in this embodiment. Users of the download manager 116 may have a user identifier (ID) and/or password depending on whether the personality specifies any authentication and/or authorization checks. Where authentication is specified, the user enters a user ID once, periodically or every time the download manager 116 is invoked with that personality. Each user could have separate user IDs for each personality. The user IDs are unique within the realm of use case run on any number of computers, but could be overlapping when considering all users and use cases together. For example, one personality of the download manager 116 could have the user ID “WilliamBoy2”, which would be unique to all download managers using that personality. Another personality could have the same WilliamBoy2 user ID to correspond to the same or a different user.

Although this embodiment uses a login for authentication, other embodiments could use other forms of authentication. Embodiments could use biometric authentication, token authentication, and/or implicit forms of authentication. In one case, the serial number or other identifier of the computing device is used for authentication without any knowledge of the user, for example. The serial number or other unique identifier can be used by the personality to report errors and provide feedback that can be attributed to that personality. Any parameter customization to the personality can be retained and associated with the serial number or unique identifier for future use when the personality is invoked in the future.

In other embodiments, the authentication could be for a number of personalities if they share userID and password or otherwise have a trust relationship. Personalities in a trust relationship would allow authentication of one be authentication for all. In one case, the authentication for the computer, operating system or an application, other than a download manager, could be used in a trust relationship that one or more personalities could rely upon. For example, the operating system login could be used as authentication for one or more personalities.

The user ID could be usable on a number of different platforms supported by the use case. For example, a movie download service may be usable on a computer, a portable video player, a Blu-Ray™ player, a set top box, etc. and use a common user ID and password for authentication. A user could login at any supported computing device with the user ID to allow the content provider cross platform tracking of the users.

Some embodiments of the download manager 116 allow concurrent servicing of downloads from multiple sources using one or multiple personalities. For example, the download manager could be downloading content from three different sites, while enforcing the use case for each respective site. In another example, the download manager 116 could be downloading six files under the same personality.

The bandwidth available and QoS of the use case could be divided among the various ongoing downloads. For example, the computer may have 300 Kbps of available bandwidth and divide that equally between five instances of the download manager. The download manager 116 could avoid or share use of the bandwidth to provide for other applications of the user computer. With the available bandwidth, some downloads could be given priority. For example, a streaming download of a live event could receive priority over a file download with little QoS requirements. The download manager 116 could go through a process of meeting minimum QoS requirements first to avoid stuttering or pixelization of streamed content and divide the remaining portion of the bandwidth among the other downloads. A portion of the bandwidth could be reserved from use by the download manager 116 to provide for other applications, for example, the download manager could be limited to 80% of the bandwidth in one embodiment.

Each personality can modify the various parameters available for customization by the personalities. Where there is no modification, default parameters would be used. Additionally, the user can modify the default or personality parameters in some embodiments. For example, the bandwidth consumed could be up to 50% of the available bandwidth as a default. A particular personality may allow up to 90% of the available bandwidth to be used, which would override the 50% default if so desired by the user. The user could later decide that both should be overridden by specifying a 10% consumption of the available bandwidth. Some settings may be made available for modification by the user, while the personality may prevent others from being modified.

Where there is identification of the user through authentication or otherwise, the customization of the parameters could be stored for future use by the personality or even shared with other personalities if so allowed. Embodiments that allow feedback to a central location could store the customization for use by other personalities on other platforms such that the user may not have to enter the override parameters multiple times.

With reference to FIG. 1B, another embodiment of a download system 100-2 is shown. This embodiment performs authentication of the user of the download manager 116, but differently from the embodiment of FIG. 1A, which performed authentication with the download controller 132. The personality specifies a content publisher 102 and specifies that the content publisher 102 performs authentication remotely. In this embodiment, the authentication function 140 is at the URI or IP address of the content publisher 102, but other embodiments could have the authentication function 140 anywhere. Unless authenticity of the user, computer or software is given by the authentication function, the download manager 116 will not operate the instance with full rights. For example, if authentication is not confirmed, a file might be downloaded, but not played or may remain encrypted until authentication is confirmed.

Referring next to FIG. 1C, yet another embodiment of a download system 100-3 is shown. This embodiment has the authentication function 140 located away from the download manager 116 and the content publisher 102. The authentication function 140 can operate for one or more personalities, even if those personalities don't share authentication information such as user ID. This embodiment does not include a personality database 148. The personality is sent from each content publisher 102 for each download. The personality may or may not be stored or cached for future downloads from the content publisher 102. The personality can be sent as a separate file, embedded in the protocol and/or metadata within the file or stream itself in various embodiments. Where there is no personality sent, a default personality can be used by the download controller 132.

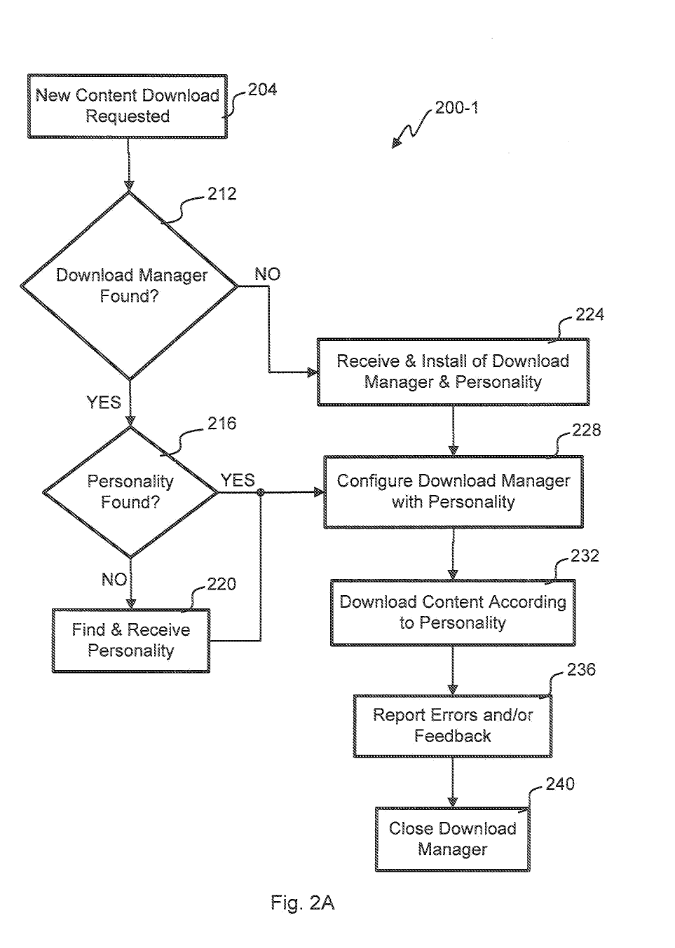

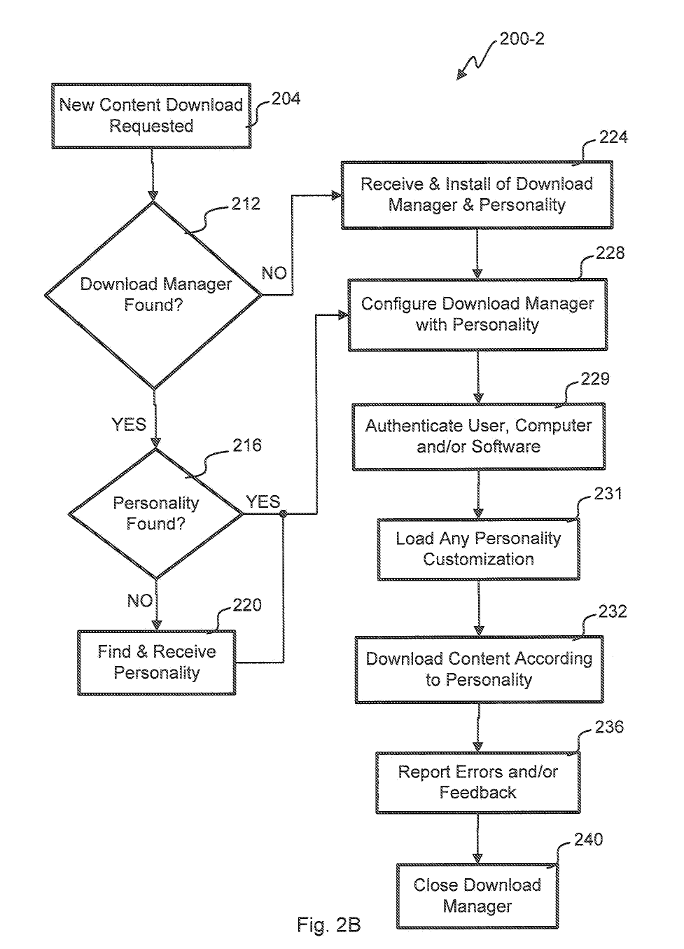

With reference to FIG. 2A, an embodiment of a process 200-1 for using the download manager 116 is shown. This process 200-1 goes through a typical situation to get the download manager 116 installed on a computer with one personality and available to other content publishers 102 to load additional personalities. The depicted portion of the process 200 begins in block 204 where a user has selected a content file for download from a first site 108 or a first content provider 112. Most browsers confirm download and install of an application, plug-in or applet. The user could confirm the desire to download the content file. Where no download manager 116 is present as determined in block 212, one is downloaded with the relevant personality in block 224 for the content requested before proceeding to block 228.

If there is already a download manager as determined in step 212, processing would go to block 216 where a determination is made on whether the relevant personality for the use case dictated by the requested content. The personality is located and loaded in block 220 if not found in block 216. Subsequent encounters with the content publisher and/or content file type will load the personality from where it is stored in the personality database 148. Some embodiments may ask for acceptance before loading the personality or perform the load automatically.

In any event, going into block 228 from any of block 216, 220 or 224 will configure an instance of the download manager 116 with the personality. The content is downloaded according to the use case defined by the personality in block 232. As dictated by the personality, error reports and feedback can be provided in block 236. After download of the requested content, the instance of the download manager 116 is closed in block 240. Some embodiments could invoke an application that might play the content during download for streaming content or could play a content file with an application after download.

With reference to FIG. 2B, an embodiment of a process 200-2 for using the download manager 116 is shown. This embodiment differs from the embodiment of FIG. 2A by adding two additional blocks between block 228 and block 232 to provide authentication and user customization. From block 228, processing goes to block 229 where the user, computer, software, operating system, etc. is authenticated for the instance of the download manager 116 as specified by the use case. In block 231, any user customization to the personality is overlaid to override default values where permitted. After block 231, processing continues to block 232 for download of the requested content as described in relation to FIG. 2A.

Referring next to FIG. 3A, an embodiment of a process 300-10 for error report and/or feedback grouping is depicted. Feedback and error reporting can respectively performed to a single site or to a defined group of sites. These grouped reports can be the same or different for the two types of reporting, namely error and feedback reporting. For example, a group of sites could have different personalities that all report to one or more addresses. A group of sites 108 could each have personalities distributed that report to a group of addresses or domains to send the reports to multiple locations. Feedback can also distributed in this way. A personality may send feedback to one group of locations and error reports to another group of locations, or both groups of locations could be the same for both feedback and error reports.

In the depicted embodiment, a hierarchy could be defined for report grouping. Three generations are shown in this example including grandparent sites 304, parent sites 308 and children sites 312. A grandparent site 304 in the hierarchy group can override the personality settings of the parent and children sites 308, 312 lower in its hierarchy. The lines between blocks show the sites 108 in the same hierarchy. An ancestor could ask for copies of some or all reporting for its progeny. In other embodiments, a site can override personality settings of an ancestor in the hierarchy.

Only grouped sites can share information within the download manager realm for this embodiment. If there is no relationship defined between the sites, the download manager 116 does not allow passing of information. In this way, the download manager 116 can operate the unrelated personalities in different threads or sandboxes. Each thread has one or more sites 108 that are serviced with the thread as defined by the one or more personalities for those sites. This embodiment reports both errors and feedback according to the same hierarchy grouping, but other embodiments could have separate hierarchies for each category of reports.

This example has a defined reporting hierarchy. Each site 108 reports to all siblings and ancestors traceable through the directional arrows. For example, the DE.TTC.nx and SD-TTC.com report to the content provider defined in both their personalities and those defined in the TTC.com and TTC.nx personalities. In another example, the TTC.com.nx site reports to the content provider defined in its personality as well as those defined in the TTC.com and TTC.nx personalities. In a different example, the TTC.com situation only the content publishers defined in the TTC.com and TTC.nx personalities are reported to.

Although this embodiment uses a hierarchy for reporting, other embodiments could use any type of grouping. For example, personalities in a same domain could cross-report.

Referring next to FIG. 3B, an embodiment of a process 300-2 for error report and/or feedback grouping is depicted. In this embodiment, reporting is performed by IP address rather than by domain. Reporting and personality sharing is depicted by arrows. For example, the sixth reporting address 316-6 allows the fifth reporting address 316-5 receive its reports. The fourth reporting address 316-4 shares its reports with the first, second and third reporting addresses 316-1, 316-2 and 316-3. The sharing could end with the block one link further in the chain that receives the arrow head or the sharing could proceed further down the chain. For example, the fourth reporting address 316-4 could share information with the third reporting address 316-3 that may be passed to the first reporting address 316-1 in one embodiment or not passed in another embodiment.

Personality sharing may align with report sharing, or not in different embodiments. In one example, the third personality associated with the third reporting address 316-3 could use the personality from the fourth reporting address 316-4. Some embodiments check for a personality before inheriting one from another reporting address 316.

While the principles of the disclosure have been described above in connection with specific apparatuses and methods, it is to be clearly understood that this description is made only by way of example and not as limitation on the scope of the disclosure.

What is claimed is:

1. A method for customizing a download manager on a user computer according to a plurality of content sources, the method comprising:
downloading the download manager onto a computing device;
downloading a first personality corresponding to a first content source that is part of the plurality of content sources;
loading the first personality to customize the download manager;
downloading first content from the first content source;
downloading a second personality corresponding to a second content source that is part of the plurality of content sources;
loading the second personality to customize the download manager; and
downloading second content from the second content source.

2. The method for customizing the download manager on the user computer according to the plurality of content sources as recited in claim 1, wherein the first and second personalities include limits on an amount of bandwidth that will be consumed from available bandwidth.

3. The method for customizing the download manager on the user computer according to the plurality of content sources as recited in claim 1, wherein:
the first content is a stream, and
the second content is a file.

4. The method for customizing the download manager on the user computer according to the plurality of content sources as recited in claim 1, wherein:
the first personality specifies a first parameter that can be customized by the user, and
the first personality specifies a second parameter that cannot be customized by the user.

5. The method for customizing the download manager on the user computer according to the plurality of content sources as recited in claim 1, wherein:
the first personality corresponds with a first use case, and
the second personality corresponds with a second use case.

6. The method for customizing the download manager on the user computer according to the plurality of content sources as recited in claim 1, wherein the first personality defines at least one of:
bandwidth requirement(s),
QoS factor(s),
reporting location(s),
authentication requirement(s),
player or application to use with content,
how the graphical user interface is customized,
information to track,
location for download of content,
security and/or privacy settings,
how customizations is inherited,
download protocol, and/or
encryption to used.

7. The method for customizing the download manager on the user computer according to the plurality of content sources as recited in claim 1, wherein:
the first personality gathers first information for reporting to a first location, and
the second personality gathers second information for reporting to a second location different from the first location.

8. The method for customizing the download manager on the user computer according to the plurality of content sources as recited in claim 1, wherein the first personality gathers different types of information for reporting in comparison to the second personality.

9. A file download system for electronically transmitting content files from a plurality of content sources to a user computing device using the Internet, the file download system comprising:
a download manager used by the user computing device, wherein the download manager comprises:
a personality database comprising a plurality of personalities for the plurality of content sources, wherein the plurality of personalities can be invoked independently when encountering a corresponding one of the plurality of content sources to customize a particular download manager; and
a reporting function that reports to different locations as defined by the plurality of personalities.

10. The file download system for electronically transmitting content files from the plurality of content sources to the user computing device using the Internet as recited in claim 9, wherein each of the plurality of personalities define a use case for a content site.

11. The file download system for electronically transmitting content files from the plurality of content sources to the user computing device using the Internet as recited in claim 9, wherein a type of content is used to determine a personality to use from the plurality of personalities.

12. The file download system for electronically transmitting content files from the plurality of content sources to the user computing device using the Internet as recited in claim 9, wherein metadata within requested content from one of the plurality of content sources specifies which personality from the plurality of personalities to use.

13. The file download system for electronically transmitting content files from the plurality of content sources to the user computing device using the Internet as recited in claim 9, wherein metadata within requested content from one of the plurality of content sources defines a personality for use in downloading the requested content.

14. The file download system for electronically transmitting content files from the plurality of content sources to the user computing device using the Internet as recited in claim 9, further comprising an authentication function that authenticates an instance of the download manager.

15. A file download manager for electronically transmitting content files from a plurality of content sources to a user computing device over the Internet, the file download manager comprising:
a download controller;
a personality database comprising a plurality of personalities for the plurality of content sources, wherein the plurality of personalities can be invoked independently when encountering a corresponding one of the plurality of content sources to customize a particular download manager; and
a reporting function that reports to different locations as defined by the plurality of personalities.

16. The file download manager for electronically transmitting content files from the plurality of content sources to the user computing device over the Internet as recited in claim 15, wherein the plurality of personalities include limits on an amount of bandwidth that will be consumed from available bandwidth.

17. The file download manager for electronically transmitting content files from the plurality of content sources to the user computing device over the Internet as recited in claim 15, wherein the download controller uses multiple personalities while downloading multiple content objects simultaneously.

18. The file download manager for electronically transmitting content files from the plurality of content sources to the user computing device over the Internet as recited in claim 15, wherein each of the plurality of personalities define a use case for a content site.

19. The file download manager for electronically transmitting content files from the plurality of content sources to the user computing device over the Internet as recited in claim 15, wherein a type of content is used to determine a personality to use from the plurality of personalities.

20. The file download manager for electronically transmitting content files from the plurality of content sources to the user computing device over the Internet as recited in claim 15, wherein metadata within requested content from one of the plurality of content sources specifies which personality from the plurality of personalities to use.

21. The file download manager for electronically transmitting content files from the plurality of content sources to the user computing device over the Internet as recited in claim 15, wherein metadata within requested content from one of the plurality of content sources defines a personality for use in downloading the requested content.

22. The file download manager for electronically transmitting content files from the plurality of content sources to the user computing device over the Internet as recited in claim 15, further comprising a tracking module that monitors usage of download controller usage by a particular personality and reports the usage to the reporting function.
